(19) United States
(12) Patent Application Publication
(10) Pub. No.: US 2016/0003788 A1
(43) Pub. Date: Jan. 7, 2016

(54) UV LIGHT EMITTING DIODE AS LIGHT SOURCE IN GAS CHROMATOGRAPHY-UV ABSORPTION SPECTROPHOTOMETRY

(71) Applicant: CHROMALYTICA AB, Malmö (SE)

(72) Inventors: Thomas LUNDEBERG, Lidingö (SE); Jonas FRIBERG, Malmö (SE); Lennart Torbjörn OLSSON, Malmö (SE); Erik SPARRE, Lomma (SE)

(21) Appl. No.: 14/768,877

(22) PCT Filed: Feb. 19, 2014
(86) PCT No.: PCT/EP2014/053261

§ 371 Date: Aug. 19, 2015

(30) Foreign Application Priority Data
Feb. 20, 2013 (SE) 1350206-7

(51) Int. Cl. G01N 30/74; G01N 21/33

(52) U.S. Cl. CPC G01N 30/74; G01N 21/33; G01N 2201/062

(57) ABSTRACT

An apparatus for analyzing a sample, including a sample receiving device, a gas chromatograph and a spectrophotometer, said spectrophotometer including a UV Light Emitting Diode as the light source, an elongated chamber and a detector. The UV light source is arranged to illuminate sample substances conducted through the chamber, and the detector is arranged to identify sample substances by UV absorption spectroscopy.

### TECHNICAL FIELD

The present invention relates to an apparatus and a method for analyzing a sample. More specifically, the present invention relates to an apparatus and a method for analyzing a sample by gas chromatography (GC) and ultraviolet (UV) absorption spectroscopy, which is called GC-UV, to detect, identify, quantify and analyze substances in samples from high to very low concentrations. Such samples are gas mixtures and or single gases gas phase samples, such as air or other gases, or other substances that are transformed into gas phase samples.

### BACKGROUND ART

The basic technology of GC-UV is known and used for various purposes. Examples of such basic technology are disclosed in U.S. Pat. No. 6,305,213 and U.S. Pat. No. 4,668,091, Verner Lagesson et. al. The apparatuses and methods disclosed in U.S. Pat. No. 6,305,213 and U.S. Pat. No. 4,668,091 relate to physical, mechanical and software control solutions and solve one of the major problems with detection of absorption of very short wavelengths (typically down to 120 nm) for identification of unknown substances in gas phase.

Gas chromatography UV absorption spectroscopy is used for identification and quantification of various gas phase substances or substances that can be transformed into gas phase. The technology is based on that substances in gas phase first passes through a column, such as a heated column, where the gas has a substance dependent velocity through the column and when the gas to be analyzed leaves the column and enters a chamber where UV light passes the gas, absorb light when the light passes the gas, in a spectral way, so the photonic spectrum relates with very high accuracy to the identity of the substance.

In GC-UV photonic signal levels and spatial resolution of substances in gas phase samples are obtained. Firstly, substances are separated in time by means of gas chromatography. Secondly, the time separated substances are conducted through a chamber in which absorption of photons of the sample gases by UV light down to 120 nm of wavelength are detected for identification and quantification of substances therein.

The introduction of the sample to the GC-UV system is usually carried out by injecting a liquid or gas sample by means of a micro litres syringe. The liquid sample is vaporized in a heated injector part of a GC unit prior to transportation to a separation column of said GC unit. A gas phase sample can also be introduced into the GC unit.

In WO2012121651 A1 an apparatus having a deuterium lamp as the light source is described.

Problems with prior art apparatuses and methods are that the analysis is inefficient, time-consuming and expensive and the light source that has so far primarily been a high cost deuterium or hydrogen discharge lamp with short lifetimes, high photonic noise that negatively affects the detection threshold, large physical volume and slow stabilization process of the light. Prior art systems suffer from abilities to efficient control the amount of light that would be preferable to be able to vary during an analyze session.

### SUMMARY OF THE INVENTION

An object of the present invention is to eliminate at least one of the problems mentioned above.

The present invention relates to an apparatus for analyzing a sample, comprising a sample receiving device, a gas chromatograph and a spectrophotometer, said spectrophotometer comprising a LED UV light source, an elongated chamber and a detector, wherein the UV light source is arranged for illumination of sample substances conducted through the chamber, and wherein the detector is arranged for identification and quantification of sample substances by UV absorption spectroscopy, characterized in that the apparatus comprises a light source consisting of an light emitting diode, a LED, comprising an emission spectrum of wave lengths below visible range of 390 nm and down to below 120 nm. The use of a LED also allows the detector such as a CCD, Charged Coupled Device to operate at its maximum signal to noise level and without saturation, by pulse modulation of the LED, synchronized to the detector. Modulation of the LED light source can be made by switching on an off the LED or by varying the electrical current to the LED to vary and control the number of photons that will be captured by a light sensitive element like a CCD, charge coupled Device to optimize at any given moment the number of photons to optimize the sensitivity of the apparatus to concentration of sample gas. Such modulation can be made to very high frequencies and either stabile or dynamically over the time the analyze sequence takes place. Dynamic modulation can then be optimized for optimizing the signal and or the signal to noise ratio at any given time in order to optimize the detection level and detection of substances to be analyzed. The modulation and subsequently the amount of emitted photons can be monitored by the detector, like a CCD array and control of the modulation can be fed back from the CCD detector via control algorithms to the LED. Such modulation can be from zero to very high frequencies and can be on and off with various duty cycle.

A LED in close proximity to the optical fiber allows light directly to enter without any focusing device.

A LED itself has a very high photonic energy density, photons per area, so in close proximity to the fiber, a substantial amount of the emitted light can enter light conductor like a fiber and the LED has a narrow distribution angle of its light emission, so at least a part of the emitted light be considered to be parallel or close to so.

The LED can be of such a type that it is primarily intended for emission of light in the visible spectra, between 390 nm and 750 nm and that by its design and nature has a sub visible spectrum of light emission with shorter wave lengths of light than visible 390 nm.

According to the present invention a LED-UV lamp is being used. Throughout the claims the lamp being used is a LED-US lamp also when it is being defined as a LED lamp.

A LED that has an initial photonic emission with shorter wave length than later perceived as visible by a transformation of wave lengths as the short wavelengths initial photons hits a fluorescent layer that emits light of longer wave lengths. The LED can be of such a type that it does not have any or have very little fluorescence material to allow the originating emitted photons with shorter wavelengths to leave the LED unit or a fluorescent layer that emits light with shorter wavelength than 390 nm.

The use of a LED also increases the signal to noise ratio by lower photonic noise that without change in or of other components increases the detection level by an improved signal to noise ratio related to use of electrically discharge light source like hydrogen or deuterium. Also the operational life of current white LED lamps is 100,000 hours. This is 11 years of continuous operation, or 22 years of 50% operation. The long operational life of a LED lamp is a stark contrast to the average life of an incandescent deuterium or hydrogen discharge lamp, which is approximately 1000 hours. If the lighting device needs to be embedded into a very inaccessible place, using LEDs would virtually eliminate the need for routine bulb replacement. This allows for the construction of very small detection units Furthermore, LEDs measure from 3 to 8 mm long and can be used singly or as part of an array. The small size and low profile of LEDs allow them to be used in spaces that are too small for other light bulbs. In addition, because LEDs give off light in a specific direction, they are more efficient in application than incandescent deuterium or hydrogen discharge lamp bulbs and fluorescent bulbs, which waste energy by emitting light in all directions. (Conventional light bulbs waste most of their energy as heat. For example, an incandescent bulb gives off 90 percent of its energy as heat, while a compact fluorescent bulb wastes 80 percent as heat (. U.S. Environmental Protection Agency: Learn About LEDs). LEDs remain cool. In addition, since they contain no glass components, they are not vulnerable to vibration or breakage like conventional bulbs.

Another key strength of LED lighting is reduced power consumption. When designed properly, an LED circuit will approach 80% efficiency, which means 80% of the electrical energy is converted to light energy. The remaining 20% is lost as heat energy. Compare that with incandescent bulbs which operate at about 20% efficiency (80% of the electrical energy is lost as heat there would be a cost savings of $65 on electricity during the year. Realistically the cost savings would be higher as most incandescent light bulbs blow out within a year and require replacements whereas LED light bulbs can be used easily for a decade without burning out.

Accordingly, low concentrations of substances in a sample can be detected and quantified in a quick and efficient manner.

The GC-UV apparatus can be arranged for analyzing samples, such as samples emanating from living cells. The apparatus can be arranged for analyzing metabolic substances found in exhaled air, saliva, sweat, blood and/or urine for detection of various deceases and metabolic activities.

The present invention also relates to a method for analyzing a sample by means of gas chromatography and ultraviolet absorption spectroscopy in combination with adsorption in a thermal desorption sorbent tube.

The invention is very versatile and can be used in various applications such as hand held portable and laboratory based bench top instruments. One particular use is for detection of metabolic or other substances emanating from living cells and tissues from living organisms, such as humans, animals and plants, and in particular substances that can be found in exhaled air, saliva, sweat, blood and urine, for detection of various deceases and metabolic activities for example caused by stress. Substances can be such as nitrogen oxide, urea, acetone, isoprene and carbon disulphide coming from diseases like gastric ulcers, asthma, diabetes, psychiatric disorders, drug abuse, stress conditions and intoxications, etc. Many of those metabolic substances in gas phase have significant high absorption of UV light in a spectrum ranging from about 120 nm wave length and longer.

Further characteristics and advantages of the present invention will become apparent from the description of the embodiments below, the appended drawing and the dependent claims.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings. The same reference numerals have been used to indicate the same parts in the figures to increase the readability of the description and for the sake of clarity. The figures are not made to scale, and the relative dimensions of the illustrated objects may be disproportional. Understanding that these drawings depict only typical embodiments of the invention and are not therefore to be considered to be limiting of its scope, the invention will be described and explained with additional specificity and detail through the use of the accompanying drawings in which:

FIGS. 1 and 2 are schematic views of a first embodiment of an apparatus for analyzing a sample by means of gas chromatography, UV-LED-UV absorption spectrophotometry.

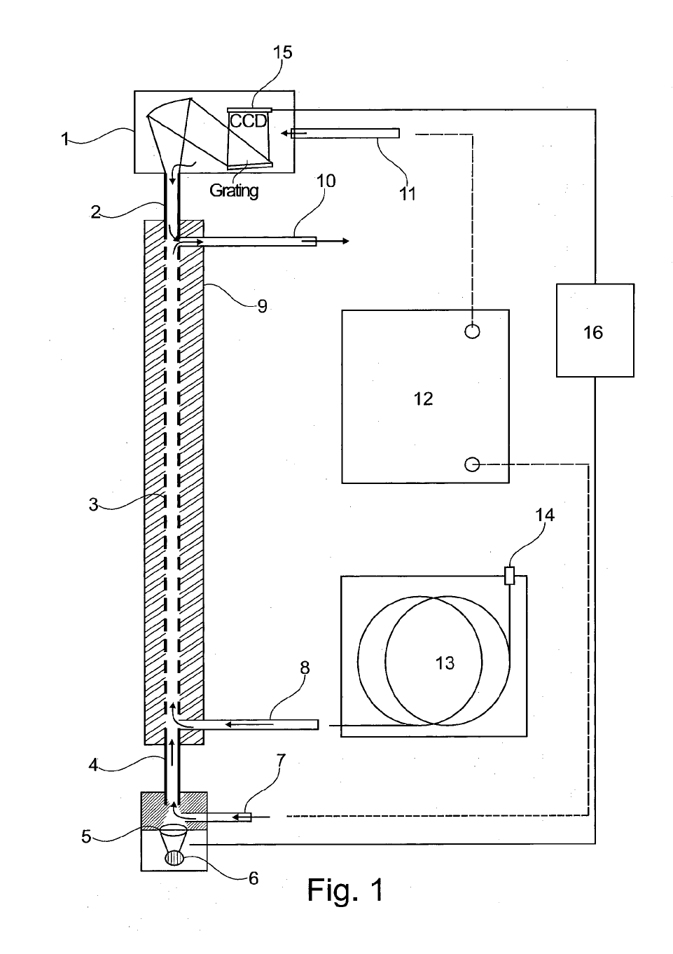

FIG. 1 shows:
1) Spectrometer
2) Optical fiber “hollow core” type, typical quarts or silica
3) “Light pipe” “hollow core” type alternative quarts, alternative Safire
4) Optical fiber “hollow core” type
5) Lens-window
6) LED light source
7) Gas flow in “make up” (typical 0.5-10 ml/min)
8) Gas flow in from GC
9) Heated body (typical 20-280 ° C.)
10) Gas flow out
11) Gas flow to Spectrometer
12) Gas flow regulators
13) Gas chromatograph (GC)
14) Sample receiving device for syringe or thermal desorption
15) CCD detector array.

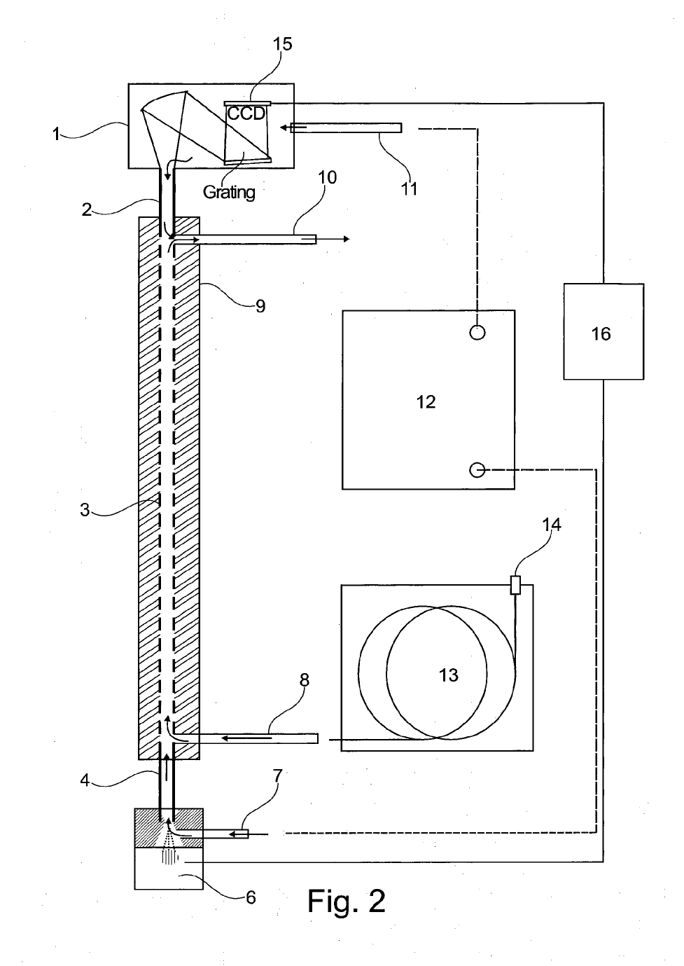

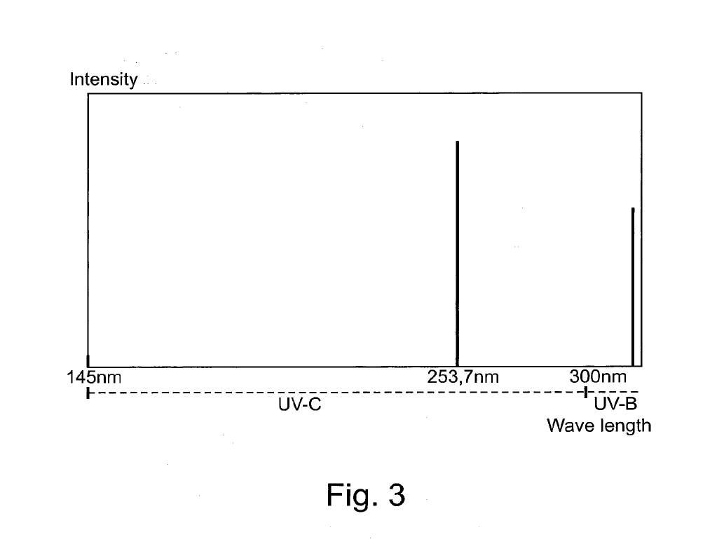

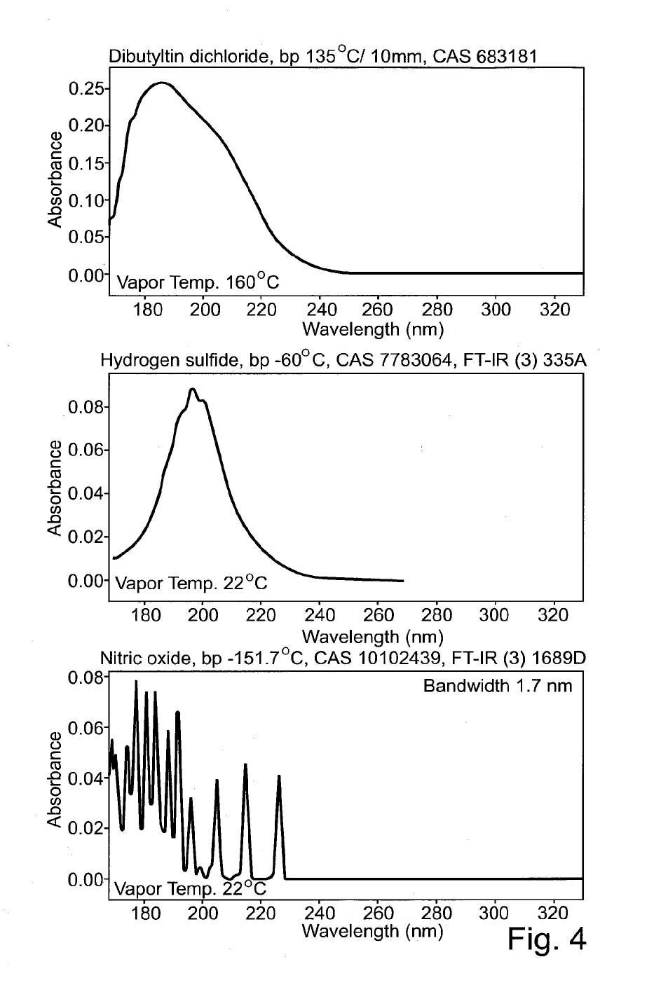

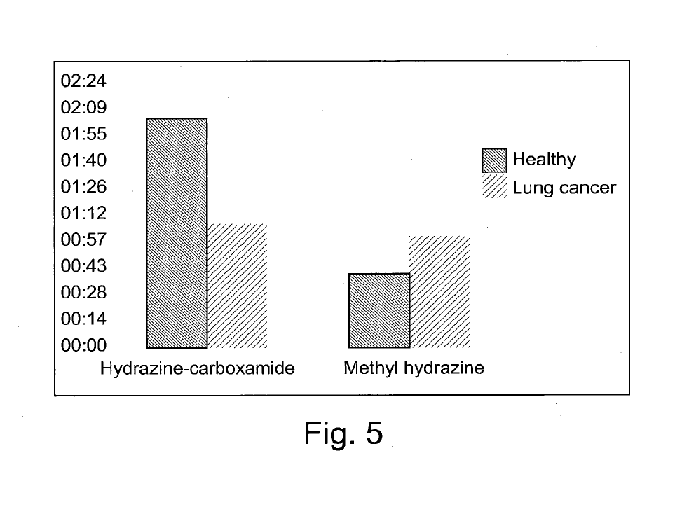

FIG. 2 shows:
1. Spectrometer
2. Optical fiber “hollow core” type, typical quarts or silica
3. “Light pipe” “hollow core” type alternative quarts, alternative Safire
4. Optical fiber “hollow core” type
5. —
6. LED light source
7. Gas flow in “make up” (typical 0.5-10 ml/min)
8. Gas flow in from GC
9. Heated body (typical 20-280 ° C.)
10. Gas flow out
11. Gas flow to Spectrometer
12. Gas flow regulators
13. Gas chromatograph (GC)
14. Sample receiving device for syringe or thermal desorption
15. CCD detector array.

FIG. 3 shows

A typical sub visible spectrum from a bright white spectrum LED. The x-axis represents from left to right the spectral range from 140 to 300 nm and the y-axis represents the intensity. Wave length for visible light is between 390 to 750 nm. The spectrum is recorded in air where photonic absorption affects the amplitude by absorption of the UV light, particularly by oxygen and water moisture below about 180 nm wave lengths.

FIG. 4 shows

Absorbance spectra of substances recorded with UV-detection.

UV used to detect Dibutyltin dichloride (DBTC) and volatile organic compounds in the environment.

DBTC is a chemical used as a polyvinyl carbonate stabilizer/catalyzer, biocide in agriculture, antifouling agent in paint and fabric. Toxic exposure may result in acute pancreatitis. Therefore monitoring of DBTC and similar compounds is crucial in occupational health (Basu Baul et al., Dibutyltin(IV) complexes containing arylazobenzoate ligands: chemistry, in vitro cytotoxic effects on human tumor cell lines and mode of interaction with some enzymes. Invest New Drugs. 2011 April; 29(2):285-99). LED-GC-UV may be used to assess workplace air samples (volatile organic compound (VOC) concentration) for example from sintering, coke making, and hot and cold forming processes in the iron and steel industry including cyclohexane, n-hexane, methylcyclohexane, trichloroethylene, 1,1,1-trichloroethane, tetrachloroethylene, chlorobenzene, 1,4-dichlorobenzene, benzene, ethylbenzene, styrene, toluene, m,p-xylene, o-xylene, 1,2,4-trimethylbenzene, 1,3,5-trimethylbenzene in the same sample. In all processes concentrations of toluene, xylene, 1,2,4-trimethylbenzene, 1,3,5-trimethylbenzene, dichlorobenzene, and trichloroethylene were high.

UV used to detect hydrogen sulfide

Gaseous sulfur-containing compounds like hydrogen sulfide are the main products in tumours (Yamagishi et al. 2012. Generation of gaseous sulfur-containing compounds in tumour tissue and suppression of gas diffusion as an anti tumour treatment. Gut. 2012 April; 61(4):554-61). Hydrogen sulfide analysed in flatus samples from patients with colon cancer and exhaled air samples from patients with lung cancer. LED-GC-UV may also be used to detect hydrogen sulfide in the air within the growing bottle of cell cancer cell lines to detect tumour growth and for the assessment of therapeutic interventions

UV used to detect Nitric Oxide (NO).

NO is nowadays used for breath analysis—monitoring inflammation in asthma. The importance of breath biomarkers in diagnosis of pulmonary disease has recently been highlighted (Zhou et al., 2012 Breath biomarkers in diagnosis of pulmonary diseases. Clin Chim Acta. 2012 Nov. 12; 413(21-22):1770-80.) LED-GC-UV allows for the simultaneous detection of nitric oxide, carbon monoxide, hydrogen peroxide and other hydrocarbons in breath samples facilitating diagnosis

FIG. 5 shows lung cancer biomarkers.

LED-GC-UV may be used for detection of lung cancer biomarkers. 42 VOCs have been identified. Normal concentration of clinically significant VOCs is 1-20 ppb (as seen with GC-MS or now with LED-GC-UV). LED-GC-UV can identify more than 1000 biomarkers in one VOC analysis. The following have not been detected in healthy individuals i.e. they may serve as markers of different forms of lung cancer: 4-Methyl-octane, 2- Ethyl-1-hexanol, 2-Ethyl-4-Methyl-1-pentanol, 2,3,4-Trimethyl-pentane, 2,3-Dimethyl-hexane, 3-Ethyl-3-Methyl-2-pentanone, 2-Methyl-4,6-octadiyn-3-one.

Taken together the LED-GC-UV results may be used to detect compounds that are not detected in healthy persons (see above) or as a relationship: quote going up (for example methyl hydrazine increases in patients with lung cancer) or going down (for example hydrazine-carboxamide decreases in patients with lung cancer) also general patterns may be used to further support the diagnosis making it more plausible thereby improving a correct treatment.

### DESCRIPTION OF EMBODIMENTS

FIGS. 1 and 2 show schematically an apparatus for analyzing a sample. For example the apparatus is arranged for analyzing a gas phase sample, such as air, exhaled air or any other suitable gas, or a liquid or solid sample, which can be transformed into a gas phase sample. For example, the apparatus is arranged for detecting metabolic substances emanating from living cells, such as metabolic substances that can be found in exhaled air, saliva, sweat, blood and urine from humans, animals or other organisms. The apparatus is, for example, arranged for detecting, identifying, and/or quantifying substances in samples. According to one embodiment, the apparatus is arranged for detecting, identifying, and/or quantifying substances such as nitrogen oxide, urea, acetone, isoprene, carbon disulphide, etc., which can be found in organisms suffering from diseases like gastric ulcers, asthma, diabetes, psychiatric disorders, drug abuse, stress conditions, intoxications, etc.

The FIG. 1 shows schematically a set up comprising GC (13), LED UV-light source (6), light pipe (3), spectrometer (1) with a CCD detector array (15), gas distribution control and gas flow regulator (12) with a gas flow from GC colon (13) by a sample receiving device (14) through light pipe (3) enclosed in an heated body (9) where the gas to be analysed is prevented to enter the spectrometer (1) by a flow of another gas (11) through the spectrometer (1) that has an opposite direction of flow relative the gas to be analysed and a flow of gas not being the gas to be analysed that is injected through a pipe (8) in close proximity to the LED UV-light source (6) between the light source (6) and the inlet (7) to the light pipe (3) through an optical fibre (4) of the gas to be analysed in order to prevent the gas to be analysed to reach the window (5) of the light source (6) and a feed back loop (16) between the CCD detector array (15) and LED UV-light source (6) the controlling the photon emission of the LED UV-light source (6) by modulation to maximize the signal to noise ratio of the CCD detector array (15) and thereby also the detection limit of gas by the apparatus.

While certain illustrative embodiments of the invention have been described in particularity, it will be understood that various other modifications will be readily apparent to those skilled in the art without departing from the scope of the appended claims. Accordingly, it is not intended that the scope of the claims appended hereto be limited to the description set forth herein.

Additionally, although individual features may be included in different embodiments, these may possibly be combined in other ways, and the inclusion in different embodiments does not imply that a combination of features is not feasible. In addition, singular references do not exclude a plurality. The terms “a”, “an” does not preclude a plurality. Reference signs in the claims are provided merely as a clarifying example and shall not be construed as limiting the scope of the claims in any way.

The FIG. 2 shows schematically a set up comprising GC (13), LED UV-light source (6), light pipe (3), spectrometer (1) with a CCD detector array (15), gas distribution control and gas flow regulator (12) with a gas flow from GC colon (13) by a sample receiving device (14) through light pipe (3) enclosed in an heated body (9) where the gas to be analysed is prevented to enter the spectrometer (1) by a flow of another gas (11) through the spectrometer (1) that has an opposite direction of flow relative the gas to be analysed and a flow of gas not being the gas to be analysed that is injected through a pipe (8) in close proximity to the LED UV-light source (6) between the light source (6) and the inlet (7) to the light pipe (3) through an optical fibre (4) of the gas to be analysed in order to prevent the gas to be analysed to reach the surface of the light source (6) and a feed back loop (16) between the CCD detector array (15) and LED UV-light source (6) controlling the photon emission of the LED UV-light source (6) by modulation to maximize the signal to noise ratio of the CCD detector array (15) and thereby also the detection limit of gas by the apparatus. The LED (6) is in close proximity to the optical fiber (4) to allow light directly to enter without any focusing device.

The LED (6) itself has a very high photonic energy density, photons per area, so in close proximity to the optical fiber (4), a sufficient and substantial amount of the emitted light can enter the light conductor, like an optical fiber (4) and the LED (6) has a narrow distribution angle of its light emission, so at least a part of the emitted light, in particular close to the center of the beam, to the be considered to be parallel or close to so.

While certain illustrative embodiments of the invention have been described in particularity, it will be understood that various other modifications will be readily apparent to those skilled in the art without departing from the scope of the appended claims. Accordingly, it is not intended that the scope of the claims appended hereto be limited to the description set forth herein.

Additionally, although individual features may be included in different embodiments, these may possibly be combined in other ways, and the inclusion in different embodiments does not imply that a combination of features is not feasible. In addition, singular references do not exclude a plurality. The terms “a” and “an” does not preclude a plurality. Reference signs in the claims are provided merely as a clarifying example and shall not be construed as limiting the scope of the claims in any way.

1. An apparatus for analyzing a sample, comprising a sample receiving device, a gas chromatograph and a least one spectrophotometer, said spectrophotometer comprising a LED UV light source, at least one elongated chamber and at least one detector, wherein at least one LED UV light source is arranged for illumination of sample substances conducted through the chamber, and wherein the detector is arranged for identification of sample substances by UV absorption spectroscopy, wherein the apparatus comprises LED UV light source that is a Light Emitting Diode, a LED, with a spectral range emitting shorter wavelengths than visible light from 120 to 390 nm.

2. An apparatus for analyzing a sample, comprising a sample receiving device, a gas chromatograph and a spectrophotometer, said spectrophotometer comprising a LED UV light source, where the LED is in close proximity to the optical fiber to allow light to enter directly in to the optical fiber without any focusing device, an elongated chamber and a detector, wherein the LED UV light source is arranged for illumination of sample substances conducted through the chamber, and wherein the detector is arranged for identification of sample substances by UV absorption spectroscopy, wherein the apparatus comprises LED UV light source that is at least one Light Emitting Diode, a LED, with a spectral range emitting shorter wavelengths than visible light from 120 to 390 nm.

3. The apparatus according to claim 1, wherein the light source utilizes sub wave lengths below 390 nm from a broad spectrum white visible spectra Light Emitting Diode, LED.

4. The apparatus according to claim 1, comprises a LED where part of the light from a LED with an initial photonic emission with shorter wave length than visible light, that is not transformed to visible light, is used for the detection in the apparatus rather than the light, later perceived as visible light by a transformation of wave lengths, as part of the initial photons hits a fluorescent layer that emits light of longer wave lengths.

5. The apparatus according to claim 1, wherein the apparatus comprises a LED as light source that has an initial photonic emission with shorter wave length than later perceived as visible by a transformation of wave lengths as the short wavelengths initial photons hits a fluorescent layer that emits light of longer wave lengths.

6. The apparatus according to claim 1, wherein the apparatus comprises a LED as light source of such a type that it does not have any or have very little or no fluorescence material to allow the originating emitted photons with shorter wavelengths to leave the LED unit.

7. The apparatus according to claim 1, wherein the apparatus comprises a LED as light source according to previous claims where the signal to noise ratio for detection is increased by the use of Light Emitting Diodes, LEDs with lower photonic noise as light source in comparison to electrical discharge light sources like Hydrogen and or Deuterium lamps.

8. The apparatus according to claim 1, wherein the apparatus comprises a feedback loop between a CCD detector array and LED UV-light source controlling the photon emission of the LED UV-light source by on-off modulation to maximize the signal to noise ratio of the CCD detector array and thereby also the detection limit of gas by the GC-UV apparatus.

9. The apparatus according to claim 1, wherein the apparatus comprises a feedback loop between a CCD detector array and LED UV-light source controlling the photon emission of the LED UV-light source by modulation of the electrical current to maximize the signal to noise ratio of the CCD detector array and thereby also the detection limit of gas by the GC-UV apparatus.

10. The apparatus according to claim 1, wherein the apparatus comprises a LED, that is of such a type, that it is primarily intended for emission of light in the visible spectra, between 390 nm and 750 nm and that by its design and nature has a sub visible spectrum of light emission with shorter wave lengths of light than visible 390 nm.

11. The apparatus according to claim 1, wherein the apparatus comprises a LED as light source to increase the signal to noise ratio by relatively lower photonic noise that without change in or of other components in such an apparatus, increases the detection level by an improved signal to noise ratio by its lower emitted photonic noise.

12. The apparatus according to claim 1, wherein the apparatus comprises a LED as light source of such a type that it fluorescence material to allow shorter wavelengths than 390 nm to leave the LED unit.

13. A method comprising analyzing a sample in gas phase emanating from living cells using the apparatus according to claim 1.
